(19) United States
(12) Patent Application Publication
(10) Pub. No.: US 2012/0113253 A1
(43) Pub. Date: May 10, 2012

(54) Residential Video Surveillance Device

(76) Inventor: Terry Slater, Surrey (CA)

(21) Appl. No.: 13/289,089

(22) Filed: Nov. 4, 2011

Related U.S. Application Data
(60) Provisional application No. 61/411,252, filed on Nov. 8, 2010.

(51) Int. Cl. H04N 7/18

(52) U.S. Cl. 348/143; 348/E07.085

(57) ABSTRACT

A video surveillance device for monitoring an area nearby the entryway to a residence. The device is a single unit that can be removably secured to an exterior door. Movement in a monitored area is perceived by a motion detector that sends an initiation signal to a video camera, which records for a pre-determined length of time and saves the resulting video to a storage media. Video files can be played back on an associated digital display. Playback may be live or at a later time. The device provides residents of a dwelling with the ability to view individuals who approach the dwelling while the resident is away, asleep or otherwise occupied. The single unit construction of the device makes it easy for users to install and remove from a door with an existing peep hole. Consequently there is no need for costly set-up or maintenance.

### CROSS REFERENCE TO RELATED APPLICATION

This application claims the benefit of U.S. Provisional Application No. 61/411,252 filed on Nov. 8, 2010, entitled “Door Monitor.”

### BACKGROUND OF THE INVENTION

1. Field of the Invention

The present invention relates to a home security surveillance device. More specifically, it relates to a video surveillance device for monitoring an area in front of a doorway. The device is especially useful in residences, where it can be used to keep a record of persons who approach an entryway.

It is the fear of many homeowners that their houses will be burglarized or vandalized. Most crimes of this nature occur late at night or while homeowners are away from their residence, making it difficult to identify the perpetrator. To address this problem some homeowners install surveillance systems around their property. Common areas to place surveillance cameras include doorways, decks, near garage entrances and overlooking areas of the property. Surveillance systems can offer users real-time or recorded footage of the monitored area. In the event of a break-in, a user can show identifying footage to the police, thereby increasing the likelihood that the perpetrator will be caught and the homeowner's property returned.

Another common issue related to security and door monitoring relates to visualizing an individual at an entryway and determining his or her identity prior to granting access. A traditional peephole provides little clarity and a small window through which to view a perspective guest. The present invention pertains to a simple device that provides an enlarged screen and viewing area for which to monitor a space in front of a doorway, which facilitates a resident's ability to greet guests and monitor this space when the owner is both at home or away from the residence.

2. Description of the Prior Art

A downside to many home security systems is their cost. Many residential video surveillance systems are complex, with multiple cameras associated with a single interior viewing station. The complexity of these systems often necessitates professional installation and upkeep, which is time consuming and costly to the homeowner. If a surveillance device can be easily installed and serviced by the homeowner, then the cost of video monitoring decreases and resultantly becomes more accessible to a wider range of users. This also makes it easy for a user to immediately address problems associated with a monitoring device instead of waiting for a service technician. An easily installed residential video surveillance device is needed and disclosed herein.

The prior art contains a variety of video surveillance systems for monitoring a doorway or entryway into a residence. These devices have familiar design and structural elements for the purposes of monitoring a designated area outside of a residence. The prior art devices use a variety of well-known means to relay recorded video to a viewing unit inside the residence. However, these devices do not disclose a single unit device that is easy to install and convenient to maintain. The present invention provides a video surveillance device that offers convenience to residents when installing, removing or maintaining the video surveillance device.

Sham, U.S. Patent Application Publication No. 2006/0221183 discloses a video monitoring security assembly for facilitating the monitoring and recording of an entryway. The assembly includes a digital camera having internal memory storage, such as a miniature CMOS or CCD camera. The device also includes a microphone, a motion sensor and a display device. The camera is located in a tube tunnel inserted into a hole disposed below the peephole of a door. A microphone is operatively connected to the camera so that audio and video recording may be made simultaneously. Recordings are stored and may then be played back to a user by means of the display device. The display device is secured to the inside of a building, preferably near the entryway being monitored, and comprises a small monitor having built-in speakers. When a visitor approaches the monitored entryway, the motion detector is triggered and activates the camera and microphone. Audio and visual input is recorded to the storage memory to await playback. A user can access video and audio playback on the viewing unit. This allows the user to see who has approached the door area.

Sham describes a camera that is located within a tunnel between the outside and inside faces of the door. Such positioning renders the camera component difficult to access if the device needs servicing. The camera's position also increases the likelihood that it will become damaged during installation because the tunnel component may experience intense jostling while the tunnel is threaded through a hole in a door. To solve these problems the present invention includes a camera that is located within the interior housing portion of the device. Sham also does not disclose covering of or the use of a peephole as part of the assembly.

Xin, U.S. Pat. No. 6,429,893 discloses a home security system for monitoring activity within a doorway area. A motion detector is placed near a door or threshold area and is operatively connected to a microcontroller to facilitate the perception of movement within the monitored area. The microcontroller is operatively connected to a video camera that records activity within the designated area. A remote viewing unit displays to a user the current activity recorded by the camera, as well as previously recorded activity. A microphone is operably coupled to the video camera for recording sound made by a visitor. Speakers connected to the viewing unit may play the recorded audio back. A second microphone is secured near the viewing unit, and is operatively connected to a set of speakers disposed near the outside video camera. In this manner a person inside the dwelling may communicate with a visitor via the microphones and associated speakers. The system disclosed by Xin is not a solitary unit that connects through a door. This device has several disconnected components, which can make installation and set up of the monitoring system difficult for a resident. The present invention provides a device having a single unit assembly that increases convenience to a user installing the device.

Tamayo, U.S. Patent Application Publication No. 2009/0273670 discloses a security system featuring remote viewing of a monitored area. A video camera monitors the selected area, preferably near a doorway or threshold to a home. The images viewed by the camera are processed by processing circuitry and then transmitted to a remote viewing unit for playback. The video camera is positioned at the interior of a door peephole so that it takes pictures through the peephole. Sensors placed in a doorbell and a doormat trigger the camera. If visitors ring the doorbell or step on the doormat, the video camera begins recording. Tamayo does not disclose a motion sensor that triggers video recording whenever movement in the area of an entryway is perceived. The present invention provides motion detection capabilities to provide accurate detection of intruders, who may avoid using doormats and doorbells so as to remain undetected.

Stuart, U.S. Pat. No. 7,012,523 discloses a video surveillance system for use in entryways of a residence. The system includes a lens positioned in the peephole of an entryway door and a camera operatively connected to the lens such that images are captured through the peephole. The camera has a viewfinder that allows a user to look through the camera lens and out the peephole. A telephone and telephone line may also be included to facilitate communication between a user of the remote viewing unit and the video camera station. The system is battery powered, or alternatively may be powered by electricity from the phone line of the device. Stuart does not disclose a means for detecting the approach of a visitor, nor does Stuart contemplate automatically initiating video recording of the monitored area. The present invention provides a motion detector for perceiving the presence of a visitor, and automatically initiating video recording after a visitor is detected.

The devices disclosed by the prior art do not address the need for an easy to install and maintain, single unit device. The current invention relates to a device for video surveillance of a doorway area. The device comprises of a single unit that can be installed in a door without the assistance of a technician. Since the components of the device are enclosed within the interior housing portion of the device, they can be conveniently serviced by a user as needed and hidden from outside onlookers. It substantially diverges in structural elements from the prior art; consequently it is clear that there is a need in the art for an improvement to the available residential video surveillance systems. In this regard the instant invention substantially fulfills these needs.

### SUMMARY OF THE INVENTION

In view of the foregoing disadvantages inherent in the known types video surveillance systems now present in the prior art, the present invention provides a new compact single unit assembly wherein the same can be utilized for providing convenience for the user when installing, removing or replacing components of the device.

The device comprises an interior housing portion and at least one support channel secured thereto. The interior housing portion is disposed on the interior of a door. The supporting channel extends through the door from the back face of the interior housing portion to the front of the door. In a preferred embodiment there is a single tunnel that extends through the pre-existing peephole bore of a door. In an alternative embodiment there is a second tunnel disposed beneath the peephole to provide additional stability to the device. These components connect to form one unit that is easily installed on an entryway door.

The internal housing portion encloses a video camera, a motion detector and a storage media. The housing may be a box placed over the peephole of the door within a dwelling. An optical cable extends through the door and is connected to the camera. This allows the camera to capture video footage of activity in front of the door. Recordings are retained on the storage media until a user accesses them. To prevent unnecessary recording, video recording is triggered by signal from a motion detection sensor.

Once video is recorded, it is transmitted along the cabling that operatively connects the video camera to a digital display disposed on the front face of the interior housing portion. Any appropriate digital display may be used, such as an LCD screen. A user can view live feed from the video camera, or watch previously recorded segments. This video playback feature provides users with a means to review any visitors that stopped by while the user was out of the house. Multiple units may be installed throughout a dwelling so that each outside entryway is properly monitored.

It is therefore an object of the present invention to provide a new and improved residential video surveillance device having all of the advantages of the prior art and none of the disadvantages.

Another object of the present invention is to provide a new and improved residential video surveillance device having components that connect to form a single unit, thereby decreasing the complexity of installation.

Yet another object of the present invention is to provide a new and improved residential video surveillance device that facilitates playback of both live and prerecorded video.

Still another object of the present invention is to provide a new and improved residential video surveillance device having a motion detection sensor such that an entryway will only be monitored when activity is perceived.

Another object of the present invention is to provide a new and improved residential video surveillance device capable of installation into an existing peephole, allowing concealed operation and easy installation.

Another object of the present invention is to provide a new and improved residential video surveillance device that allows real-time or delay viewing of activity in front of a doorway, which can be communicated directly on a digital display, saved for later viewing, transmitted either wirelessly or via an Ethernet connection for external viewing through a web interface or email service.

A further object of the present invention is to provide a new and improved residential video surveillance device having resilient and durable construction.

Other objects, features and advantages of the present invention will become apparent from the following detailed description taken in conjunction with the accompanying drawings.

### BRIEF DESCRIPTIONS OF THE DRAWINGS

The above invention will be better understood and the objects set forth above as well as other objects not stated above will become more apparent after a study of the following detailed description thereof. Such description makes use of the annexed drawings wherein like numeral references are utilized throughout.

FIG. 1 shows a front view of a preferred embodiment of the residential video surveillance device, installed along the interior of a door and within a peephole.

FIG. 2a shows a cross-section of an embodiment of the residential video surveillance device with a single support tunnel. FIG. 2b shows a cross-section of an alternative embodiment of the residential video surveillance device, having two support tunnels.

FIG. 3 shows an enlarged view of the front of a door having the preferred embodiment of the residential video surveillance device installed.

FIG. 4 shows a block diagram of an embodiment of the residential video surveillance system.

FIG. 5 shows a block diagram of an alternate embodiment of the residential video surveillance system, wherein wireless communication capabilities are incorporated.

### DETAILED DESCRIPTION OF THE INVENTION

Reference is made herein to the attached drawings. Like reference numerals are used throughout the drawings to depict like or similar elements of the residential video surveillance device. For the purposes of presenting a brief and clear description of the present invention, the preferred embodiment will be discussed as used for monitoring an entryway of a domicile. This is for representative purposes only and should not be considered to be limiting in any respect.

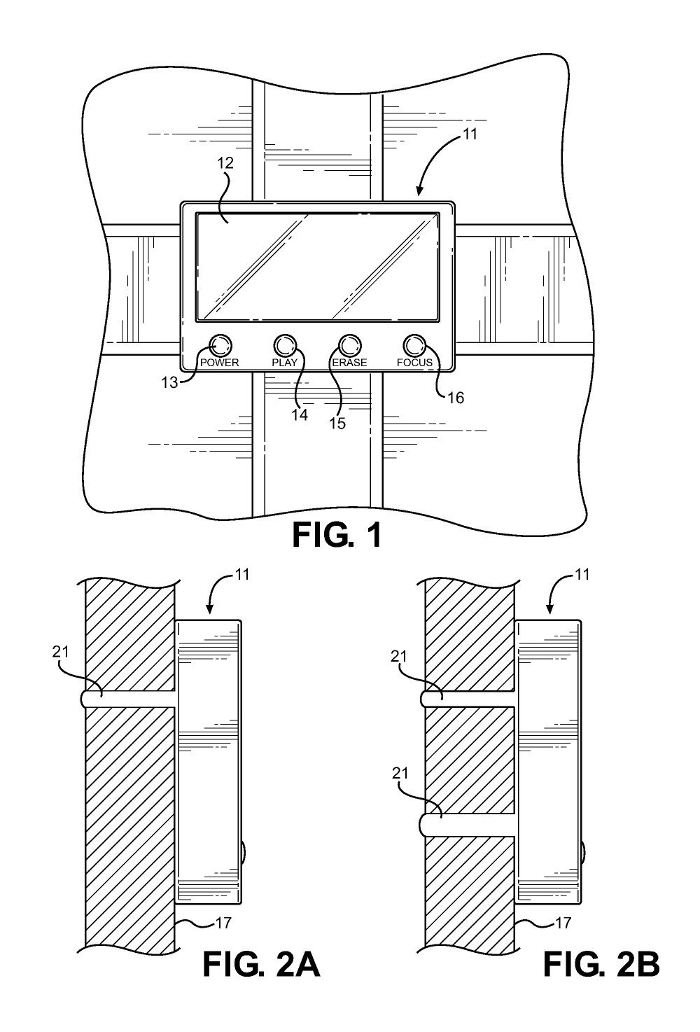

Referring now to FIG. 1, there is shown an interior housing portion 11 of the present video surveillance device. The interior housing portion abuts against the interior surface of a door when the device is installed. A digital display panel 12 such as an LCD or similar digital display provides a user with visual representation of activity captured by the device. There are several buttons disposed along the front surface of the interior housing. These buttons include a power button 13, a play/pause button 14, an erase button 15 and a focus button 16. The power button turns the digital display on and off, to conserve battery reserves when the device is not in use. Optionally, an indicator light may be housed within, and operatively connected to the power button so that when the device is in use, the power button illuminates.

The other buttons on the viewing screen allow a user to manipulate the playback of video. Video may be initiated or paused by depressing the play/pause button. Pausing a video may be particularly useful when used in conjunction with the focus button, which permits a user to zoom in and out on a region of the video screen. This function allows a user to get a close-up detailed view of visitors. When the user is completed reviewing a video, the video may be deleted by pressing the erase button, or retained by simply turning the device off. The buttons may also be used in a menu mode to toggle through menu options such as screen brightness, contrast, stored video and similar selections. By utilizing the control buttons, users may view live or recorded video playback whenever they so desire.

Referring now to FIG. 2a, there is shown a cross-section of the device installed onto a door. The interior housing 11 is snuggly positioned against the interior of the door 17. A support tunnel 21 extends from the rear surface of the interior housing through the door. It is hollow and forms a protective sheath for an optical cable and any additional wiring that extends from the interior housing to the peephole lens. The support tunnel may be cylindrical, rectangular or any other shape suitable for insertion through a peephole. This embodiment reduces the need to alter the door peephole and reduces the risk of damage thereto. An alternative embodiment is shown in FIG. 2b and comprises a first and second tunnel. One tunnel extends through the peephole in the door and a second tunnel extends through a bore beneath the peephole. In either embodiment, the tunnel removably secures the interior housing to a door and provides structural support for the installed device and a passageway for the recording and viewing means through the door.

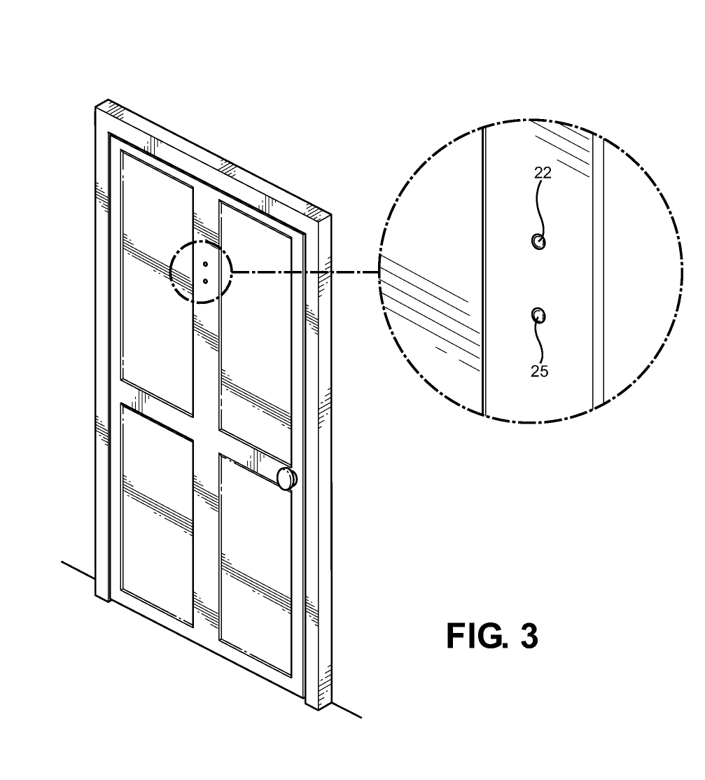

Referring now to FIG. 3, there is shown a magnified view of the exterior of a door with an alternative embodiment of the present video surveillance device installed. A first lens protrudes 22 from the peephole of the door. An optical cable extending through a support tunnel records video through the peephole lens. Positioned beneath the first lens is a second lens 25. The second lens is associated with a motion detection sensor. The size and shape of the second lens may vary according to the type of motion detection employed. In the preferred embodiment of the device there is no second lens. Only the peephole lens is present, and both video recording and motion detection are accomplished through the single lens.

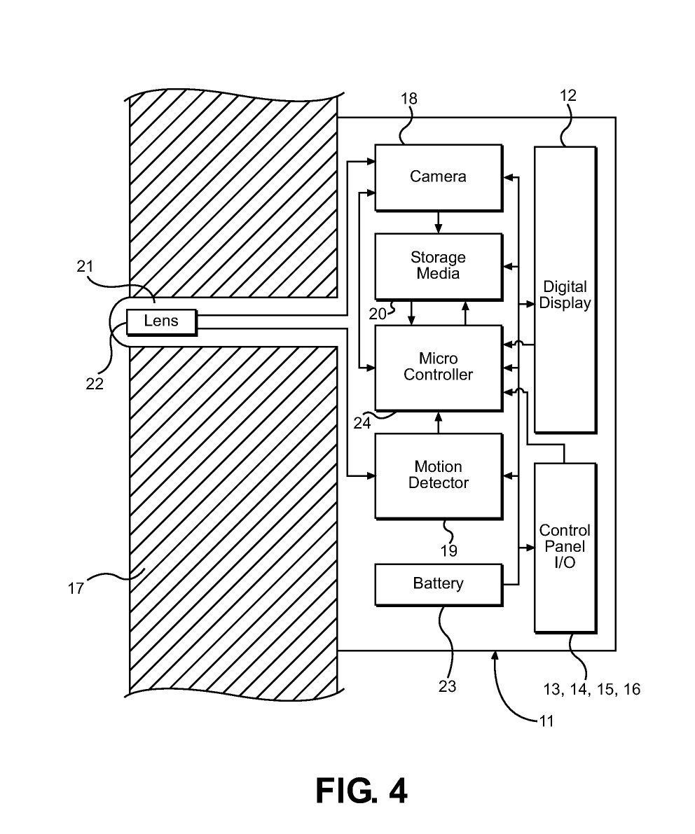

Referring now to FIG. 4, there is shown a block diagram of the present residential video surveillance device. The interior housing 11 encloses the video camera 18, storage media 20, motion detector 19, a battery 23 and a microcontroller 24. The motion detector perceives movement through an associated lens 22. Any type of optical motion detection method may be used for sensing movement in the monitored area. Preferred methods include infrared or laser based motion detection sensors, however the device is not limited to these sensor types. Since optical motion detection is used, an associated lens 22 must provide “line of sight” between the monitored area and the detection lens. Once the motion detector 19 perceives movement, a signal is sent to the microcontroller 24. Imbedded programming within the microcontroller receives the signal and prompts appropriate action such as instructing the video camera 18 to initiate video recording. Light travels through the lens to the video camera 18 where the light is processed into video signals. Video signals are passed to the microcontroller 24, which compresses the signals using a video codec such as mpeg or the like for storage 20 thereof. The compressed video files are stored on a storage media 20 until a user is ready to view them.

The interior housing also contains the digital display 12 and the control panel I/O 13,14,15,16. When a user requests a video file, it is sent to the digital display for playback. Optionally, playback may include a time and date stamp displayed in a corner of the screen, to inform a user of the time video recording commenced. The user can control this playback of video by interacting with the control panel I/O. A variety of playback options is provided and may differ according to the model of video surveillance device.

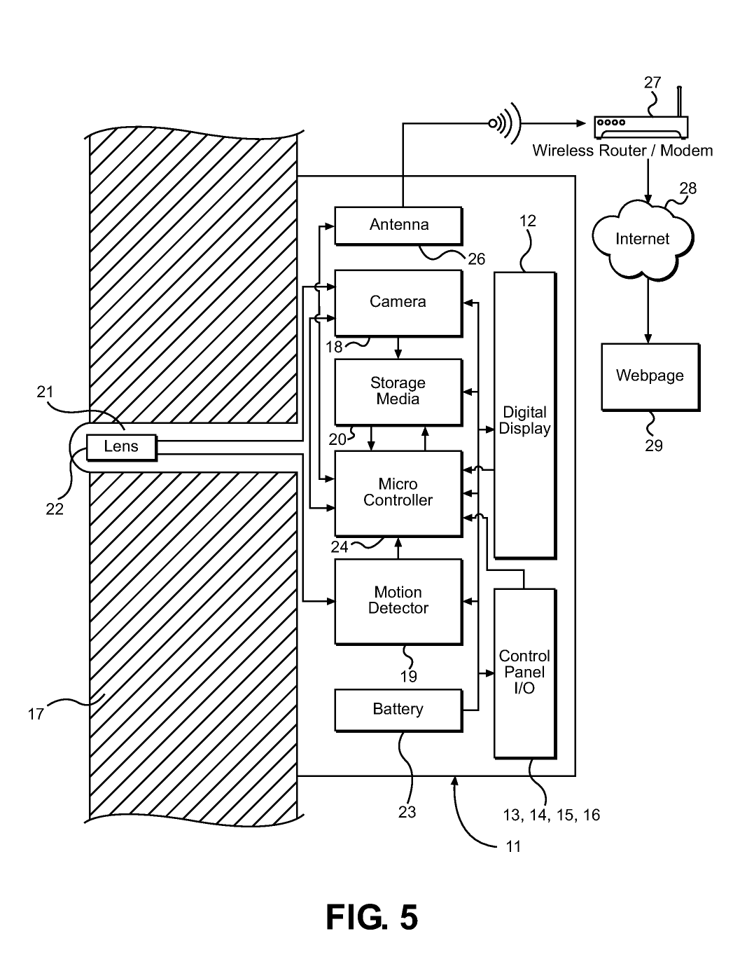

Referring now to FIG. 5 there is shown a block diagram of an alternative embodiment of the device. An antenna 26 is housed within the interior housing and is operatively connected to the microcontroller 24. A user can use the control panel I/O to configure the device to send recorded video and images to a designated email address or website 29. Once the micro controller initiates video recording and video signals are compressed, the video files are sent to the antenna for transmission. The antenna utilizes a wireless protocol such as 802.11 to send video and/or images to a wireless data receiver such as a router or modem 27. The wireless router/modem sends the files to a designated website 29 via the Internet 28. This embodiment allows a resident to view video footage of the monitored area while he or she is away from the dwelling or in a remote part of the dwelling. Depending on user preferences and the size of the storage media 20, the videos may be physically stored on the media 20, or optionally transmitted and subsequently erased from the device to save storage space. These are considered options for which imbedded programming within the microcontroller provides to the user interface, which is displayed on the digital display 12 or controlled remotely 29. The user may configure the device based on options provided, which is dependent on the level control the software provides. It is desired to have these optional features be programmable by the user to suit his or her needs and preferences.

In both the preferred and alternative embodiments of the device, the elements of the device are powered by a replaceable battery 23 located within the interior housing 11. Batteries such as lithium based, alkaline, cadmium or the like may be used. Along the rear face of the interior housing there is disposed an access panel that can be removed to give a user access to replace the device battery as necessary. To replace the battery the user disengages the support tunnels from the door, removes the access panel, removes the old battery, and places a new battery in the device. The device can then be reinstalled quickly and easily by reversing these steps.

In an alternative embodiment of the disclosed device, the housing 11 and all associated components are integrated into a door such that the door may be installed with the device in-place from the door or security company manufacturer. The housing may further be condensed into the door, wherein the display screen and control buttons protrude from within cutouts in the rear surface of the door. NC power provides energy to power this embodiment of the device. A power cord is housed within the door and extends between the device and a small aperture near along the hinge of the door. A power plug is disposed at the end of the power cord and outside the door to allow a user to electrically connect the device to a power outlet. Alternatively, the device may be hardwired into existing wiring within the dwelling, requiring no nearby electrical receptacle. The need for user installation and/or removal of the device into an existing door is eliminated making it easier and more convenient for persons who do not wish to, or are incapable of, installing the device themselves.

In use an individual installs the device onto entryway door or hangs the integrated device and door on a doorway. Once powered, the device provides monitoring capability in front of the doorway for the user. The motion detection sensor perceives any motion within the vicinity of the device and signals for the initiation of recording. Video of the vicinity is recorded by the camera and stored for playback at a later time or transmitted over a network for external playback or storage. If the user is home and hears a visitor approaching, the user may access the live playback feature to see who is at the doorway prior to opening the door. If the user is not at home when a visitor approaches, the user may check for newly stored video recordings when he or she returns home or via a remote interface that provides real-time and prerecorded playback via an internet or network capable device. When the user desires to view video surveillance footage from the digital display, he or she presses the power button to turn on the display screen. The user may watch the most recent video by pressing the play/pause button or select from other available options. After the desired videos are watched, the user may turn the screen off by pressing the power button a second time. The device will continue to monitor the selected area. The size of the internal storage media, or the settings of the device, will determine the amount of video that is saved for playback. The most robust method is clearly physically storing the playback on the storage media within the housing, while also transmitting a copy of the playback to a remote source. The choice of options is dependent on the user preferences and the given situation.

Overall, the device provides a convenient monitoring device that improves one's ability to monitor activity in front of a doorway without physically being present or setting up an obvious or expensive surveillance system. The device is compact, making it virtually undetectable from the outside of a door, while its functionality provides the user flexibility with regard to the methods of its use. These include remote viewing, physically viewing and operating the device from behind the door, and watching either real-time or delayed recordings from previous activity. In this way, the user is provided a device that allows monitoring and improved security, which can be established at multiple entryways to broaden the monitored area. The present invention can operate in a number of scenarios, and is an alternate means of securing and monitoring a residence, wherein higher-end security systems and services may be too expensive or intrusive.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim the following:

1) A video surveillance device for mounting on the interior of a door, comprising:
a housing having a front face, a rear face, and four sides that defines an interior space;
a camera;
a motion detection sensor;
a digital display;
a plurality of buttons for controlling the device;
a storage media;
a microcontroller operatively connected to said camera, said motion detector, said storage media, said digital display and said plurality of buttons;
a battery;
at least one hollow support tunnel having a peephole lens, secured to said rear face of said protective housing, extending from said interior housing and through an bore extending through said door;
a first cable extending through said support tunnel from said peephole lens to said camera, and operatively connected to said camera to enable said camera to record images through said peephole lens;
a second cable extending through said support tunnel operatively connecting said motion detector to said microcontroller for sending a signal to said microcontroller upon the appearance of motion in front of said door.

2) The device of claim 1, wherein said motion detection sensor is an optical detector.

3) The device of claim 2, wherein said optical motion detection sensor uses infrared detection.

4) The device of claim 2, wherein said optical motion detection sensor uses laser detection.

5) The device of claim 1, wherein said camera is a digital video camera.

6) The device of claim 1, wherein said plurality of buttons includes a power button having an associated indicator light that illuminates when said digital display is on.

7) The device of claim 1 further comprising a first and second support channel, said first channel supporting said peephole lens and said second channel supporting said motion detection sensor.

8) The device of claim 1 further comprising an antenna operatively connected to said microcontroller and capable of transmitting streaming or pre-recorded multimedia files to a wireless router or modem.

9) The device of claim 8, wherein said wireless router or modem is adapted to transmit said multimedia files to a designated email address or website address, via a network.

10) A video surveillance device for mounting on the interior of a door, comprising:
a housing having a front face, a rear face, and four sides that defines an interior space;
a camera;
a motion detection sensor;
a digital display;
a plurality of buttons for controlling the device;
a storage media;
a microcontroller operatively connected to said camera, said motion detector, said storage media, said digital display and said plurality of buttons;
a battery;
a first and second support channel secured to said rear face of said protective housing, extending from said interior housing and through an bore extending through said door;
said first channel supporting said peephole lens and said second channel supporting said motion detection sensor;
a first cable extending through said first support tunnel from said peephole lens to said camera, and operatively connected to said camera to enable said camera to record images through said peephole lens.
a second cable extending through said second support tunnel operatively connecting said motion detector to said microcontroller for sending a signal to said microcontroller upon the appearance of motion in front of said door.

11) The device of claim 10, wherein said motion detection sensor is an optical detector.

12) The device of claim 11, wherein said optical motion detection sensor uses infrared detection.

13) The device of claim 11, wherein said optical motion detection sensor uses laser detection.

14) The device of claim 10, wherein said camera is a digital video camera.

15) The device of claim 10, wherein said plurality of buttons includes a power button having an associated indicator light that illuminates when said digital display is on.

16) The device of claim 10 further comprising an antenna operatively connected to said microcontroller and capable of transmitting streaming or pre-recorded multimedia files to a wireless router or modem.

17) The device of claim 10, wherein said wireless router or modem is adapted to transmit said multimedia files to a designated email address or website address, via a network.

18) A video surveillance device for mounting on the interior of a door, comprising:
a door having a front surface, a rear surface, and four sides that define an interior space, one side defining a hinge surface;
an interior housing enclosed within said door;
a camera;
a motion detection sensor;
a digital display protruding from said rear surface of said door;
a plurality of buttons for controlling the device protruding from said rear surface of said door;
a storage media;
a power cord extending from said interior housing to an aperture along said door hinge surface;
a microcontroller operatively connected to said camera, said motion detector, said storage media, said digital display and said plurality of buttons;
at least one hollow support tunnel having a peephole lens, housed within said door, extending through said door from a front surface to a rear portion of said interior housing;
a first cable extending through said support tunnel from said peephole lens to said camera, and operatively connected to said camera to enable said camera to record images through said peephole lens;
a second cable extending through said support tunnel operatively connecting said motion detector to said microcontroller for sending a signal to said microcontroller upon the appearance of motion in front of said door.

19) The device of claim 18 further comprising a first and second support tunnel, said first channel supporting said peephole lens and said second channel supporting said motion detection sensor.

20) The device of claim 18 further comprising an antenna operatively connected to said microcontroller and capable of transmitting live or pre-recorded multimedia files to a wireless router or modem, and wherein said wireless router or modem is adapted to transmit said multimedia files to a designated email address or website address, via a network.
